(19) United States
(12) Patent Application Publication
(10) Pub. No.: US 2020/0234358 A1
(43) Pub. Date: Jul. 23, 2020

(54) INFORMATION PROCESSING APPARATUS, INFORMATION PROCESSING METHOD, AND PROGRAM

(71) Applicant: TOYOTA JIDOSHA KABUSHIKI KAISHA, Toyota-shi (JP)

(72) Inventors: Shinichiro FUJII, Kawasaki-shi (JP); Hiroe FUKUI, Toyohashi-shi (JP); Takashi GOTO, Okazaki-shi (JP); Tatsuya SHIGEKIYO, Okazaki-shi (JP); Kuniaki JINNAI, Nagoya-shi (JP); Naoto SASAGAWA, Nishio-shi (JP)

(73) Assignee: TOYOTA JIDOSHA KABUSHIKI KAISHA, Toyota-shi (JP)

(21) Appl. No.: 16/710,182

(22) Filed: Dec. 11, 2019

(30) Foreign Application Priority Data
Jan. 18, 2019 (JP) 2019-006894

(51) Int. Cl. G06Q 30/06; G06Q 10/08

(52) U.S. Cl. CPC G06Q 30/0631; G06Q 30/0639; G06Q 30/0605; G06Q 10/08355; G06Q 10/087

(57) ABSTRACT

Disclosed is an information processing apparatus including a controller. The controller is configured to execute acquiring index information representing a tendency having interest in a commodity of a store visit user in an autonomous traveling vehicle as a first store, selecting a recommended commodity out of stock in the first store based on the index information, and generating a command to a carrier apparatus configured to carry a commodity between the autonomous traveling vehicles or an autonomous traveling vehicle as a second store dealing in the selected recommended commodity so as to move the recommended commodity from the autonomous traveling vehicle as the second store to the autonomous traveling vehicle as the first store.

### INCORPORATION BY REFERENCE

The disclosure of Japanese Patent Application No. 2019-006894 filed on Jan. 18, 2019 including the specification, drawings and abstract is incorporated herein by reference in its entirety.

### BACKGROUND

### 1. Technical Field

The present disclosure relates to an information processing apparatus, an information processing method that is executed by at least one computer, and a program.

### 2. Description of Related Art

A technique disclosed in Japanese Unexamined Patent Application Publication No. 2009-181491 (JP 2009-181491 A) is directed toward preparing an optimum inventory quantity of commodities in each store, thereby restraining out-of-stock of commodities and promoting sales of commodities.

### SUMMARY

On the other hand, in each store, such as a retail store, for example, there is a need to prepare commodities desired to be provided to a user, such as a customer, in stock. However, since a commodity needed for each user who visits a store is different, it is not easy to prepare an inventory enough to satisfy desire of many users. There is a limit to an area of each store, and there is also a limit in preparing needed commodities in stock. Accordingly, the disclosure provides a technique that enables suitable provision of a commodity to a user who visits a certain store, without replenishing an inventory of the commodity in advance.

A first aspect of the disclosure relates to an information processing apparatus including a controller. The controller is configured to execute acquiring index information representing a tendency having interest in a commodity of a store visit user in a first store, selecting a recommended commodity out of stock in the first store based on the index information, and generating a command to a carrier apparatus configured to carry a commodity between the first store and a second store dealing in the selected recommended commodity or the second store so as to move the selected recommended commodity from the second store to the first store. A second aspect of the disclosure relates to an information processing method that is executed by at least one computer, such as the above-described information processing apparatus. A third aspect of the disclosure relates to a program that causes at least one computer, such as the above-described information processing apparatus, to execute the information processing method.

With the information processing apparatus, it is possible to suitably provide a commodity to a user who visits a certain store, without replenishing an inventory of the commodity in advance.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic configuration diagram of a system of a first embodiment;

FIG. 2 is a schematic configuration diagram of an autonomous traveling vehicle in the system of FIG. 1;

FIG. 3 is a schematic configuration diagram of a server apparatus in the system of FIG. 1;

FIG. 4 is a schematic configuration diagram of a carrier apparatus in the system of FIG. 1;

FIG. 5 is a flowchart in the system of FIG. 1;

FIG. 6A is a diagram conceptually showing a part of a commodity information database as an example in the system of FIG. 1;

FIG. 6B is a diagram conceptually showing a part of the commodity information database as an example in the system of FIG. 1;

FIG. 7 is a schematic configuration diagram of an autonomous traveling vehicle in a system of a second embodiment;

FIG. 8 is a schematic configuration diagram of a server apparatus in the system of the second embodiment;

FIG. 9 is a flowchart in the system of the second embodiment;

FIG. 10 is a schematic configuration diagram of an autonomous traveling vehicle in the system of the third embodiment;

FIG. 11 is a schematic configuration diagram of a server apparatus in the system of the third embodiment;

FIG. 12 is a flowchart in the system of the third embodiment;

FIG. 13 is a schematic configuration diagram of a system of a fourth embodiment; and

FIG. 14 shows a part of a flowchart in the system of FIG. 13.

### DETAILED DESCRIPTION OF EMBODIMENTS

Hereinafter, an information processing apparatus, an information processing method in the information processing apparatus, and a program according to an embodiment of the disclosure will be described referring to the drawings. First, a first embodiment of the disclosure will be described.

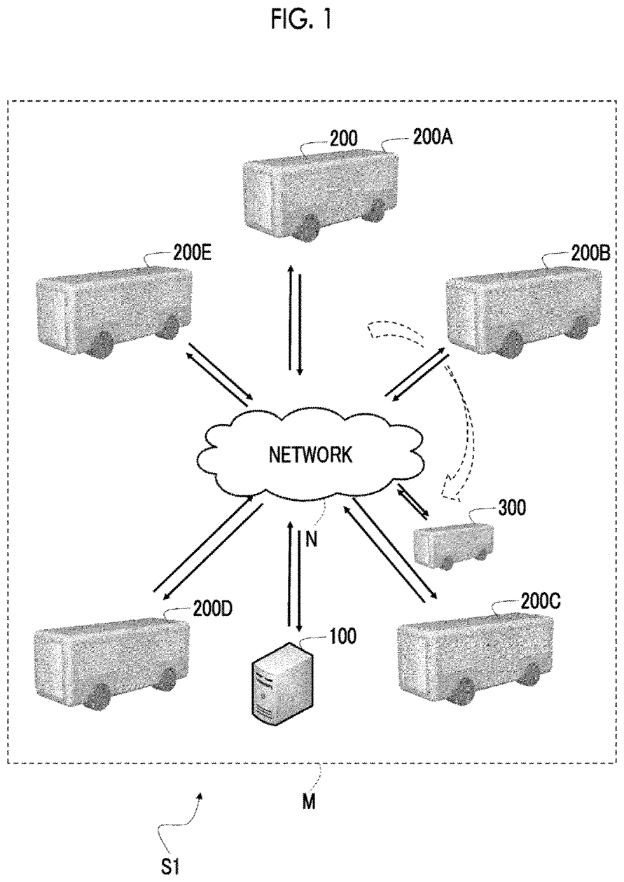

FIG. 1 is a schematic configuration diagram of a system S1 according to the first embodiment of the disclosure. The system S1 includes a server apparatus 100, a plurality of autonomous traveling vehicles 200, and a carrier apparatus 300. The server apparatus 100 is a computer on a network N. The server apparatus 100 is configured to perform communication with the autonomous traveling vehicles 200 (200A, 200B, . . . ) and the carrier apparatus 300. In FIG. 1, five vehicles 200A, 200B, 200C, 200D, 200E are represented as the autonomous traveling vehicles 200 that can perform communication with the server apparatus 100. Note that the five autonomous traveling vehicles 200A to 200E are just an example of the autonomous traveling vehicles substantially constituting one mall M. The number of autonomous traveling vehicles 200 constituting the mall M is not limited to five, may be any number, for example, ten. In FIG. 1, the server apparatus 100 is shown in the mall M. However, in the first embodiment, the server apparatus 100 is actually positioned outside the mall M. An actual position of the server apparatus 100 may be any position, for example, may be positioned in the mall M. The mall M is a so-called shopping mall, and may also be referred to as a shopping center. In the shopping mall of the embodiment, stores are constructed by the autonomous traveling vehicles 200. However, the mall M may include autonomous traveling vehicles 200 that can carry packages to a shopping district including a normal walk or commercial facilities constructed indoors.

The autonomous traveling vehicles 200 are also referred to as electric vehicle (EV) pallets. The autonomous traveling vehicles 200 are moving objects capable of autonomous driving and unmanned driving, and have various sizes according to purposes. For example, the autonomous traveling vehicle 200 having various sizes including a small vehicle of a size suitable for transporting several books and a large vehicle capable of carrying a person and an object. In particular, in the embodiment, the autonomous traveling vehicles 200 are vehicles usable as mobile stores, respectively. As the mobile stores, a retail store, a restaurant, and the like can be known, and a clothing store, a shoe store, a flower store, and a coffee shop can be exemplified. Hereinafter, description will be provided assuming that the autonomous traveling vehicle 200A functions as a mobile store of a clothing store, and the autonomous traveling vehicle 200B functions as a mobile store of a shoe store.

Each of the autonomous traveling vehicles 200 has a control function and a communication function of controlling the autonomous traveling vehicle 200, providing a user interface with a user who uses the autonomous traveling vehicle 200, transmitting and receiving information to and from various servers on the network N, and the like. The autonomous traveling vehicle 200 can provide the user with functions and services added by various servers on the network in cooperation with various servers on the network N in addition to processing executable by the autonomous traveling vehicle 200 alone. The autonomous traveling vehicle 200 is not necessarily an unmanned vehicle. For example, a sales personnel, a service personnel, a security personnel, or the like may board the autonomous traveling vehicle 200. The autonomous traveling vehicle 200 may not necessarily be a vehicle capable of complete autonomous traveling. For example, the autonomous traveling vehicle 200 may be a vehicle in which a person performs driving and supports driving according to circumstances. In the embodiment, the autonomous traveling vehicle 200 can travel based on a predetermined command, for example, a predetermined operation command, can function as a mobile store, and can pick up or deliver, for example, a package.

In addition, the autonomous traveling vehicle 200 may have a function of receiving a request from the user, responding to the user, executing predetermined processing to the request from the user, and reporting a processing result to the user. In a case where a request among the requests from the user cannot be processed by the autonomous traveling vehicle 200 alone, the autonomous traveling vehicle 200 may process the request in cooperation with various servers, for example, may transfer the request to the server apparatus 100 and may process the request in cooperation with the server apparatus 100.

Here, the autonomous traveling vehicle 200 may be an apparatus that commands operation or the like to other autonomous traveling vehicles 200. In a case where the autonomous traveling vehicle 200 is a mobile store, the autonomous traveling vehicle 200 can acquire index information representing a tendency having interest in a commodity of a user (hereinafter, referred to as a store visit user) who visits the autonomous traveling vehicle 200 and can generate a command to other autonomous traveling vehicles 200. Then, the autonomous traveling vehicle 200 can transmit the command to other autonomous traveling vehicles 200 indirectly or directly. Furthermore, the autonomous traveling vehicle 200 can transmit the command to the carrier apparatus 300 configured to carry a commodity between the autonomous traveling vehicles 200 and can command operation or the like to the carrier apparatus 300.

The server apparatus 100 is also an apparatus that commands operation or the like to the autonomous traveling vehicle 200. Similarly to the autonomous traveling vehicle, the server apparatus 100 is configured to acquire, from a certain autonomous traveling vehicle 200 as a mobile store, index information representing a tendency having interest in a commodity of a user who visits the autonomous traveling vehicle 200, generate a command to other autonomous traveling vehicles 200, and transmit the command to other autonomous traveling vehicles 200. The server apparatus 100 may transmit the command to the carrier apparatus 300 configured to carry a commodity between the autonomous traveling vehicles 200 and may command operation or the like to the autonomous traveling vehicles 200. Note that, in the first embodiment, the acquisition of the index information of the store visit user and the generation of the command based on the index information are primarily executed by the autonomous traveling vehicle 200.

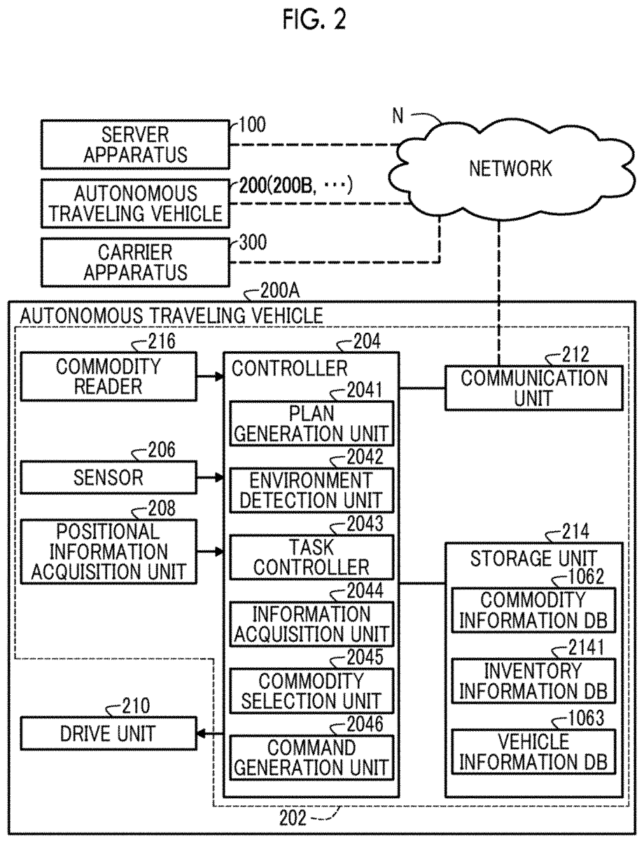

Here, the configuration of one autonomous traveling vehicle 200A among the autonomous traveling vehicles 200 in the mall M will be described referring to FIG. 2. Note that other autonomous traveling vehicles 200 in the mall M have the same configuration as the autonomous traveling vehicle 200A. However, a sensor that acquires the index information of the user, for example, a commodity reader 216 described below may be different among the autonomous traveling vehicles 200 according to the type of store, for example, the type of clothing store, shoe store, or the like.

The autonomous traveling vehicle 200A of FIG. 2 includes an information processing apparatus 202, and has a controller 204 that substantially has the functions of the information processing apparatus 202. The autonomous traveling vehicle 200A can travel according to an operation command acquired from the server apparatus 100. Specifically, the autonomous traveling vehicle 200A generates a traveling route based on the operation command acquired through the network N and travels using an appropriate method while sensing the surroundings of the vehicle.

The autonomous traveling vehicle 200A includes, in addition to the controller 204, a sensor 206, a positional information acquisition unit 208, a drive unit 210, a communication unit 212, and a storage unit 214. The autonomous traveling vehicle 200A operates with electric power supplied from a battery.

Here, the sensor 206 is a unit that performs sensing of the vehicle surroundings, and typically includes a stereo camera, a laser scanner, a lidar (light detection and ranging or laser imaging detection and ranging), a radar, or the like. Information acquired from the sensor 206 is transmitted to the controller 204. The sensor 206 includes a sensor that is provided for allowing the host vehicle to perform autonomous traveling. The sensor 206 may include a camera that is provided in a vehicle body of the autonomous traveling vehicle 200. For example, the sensor 206 can include an imaging apparatus using an image sensor, such as charged-coupled devices (CCD), a metal-oxide-semiconductor (MOS), or a complementary metal-oxide-semiconductor (CMOS). A plurality of camera may be provided at a plurality of places of the vehicle body. For example, cameras may be provided on a front side, a rear side, and right and left sides of the vehicle body.

The positional information acquisition unit 208 is a unit that acquires a current position of the vehicle, and typically includes a global positioning system (GPS) receiver or the like. Information acquired by the positional information acquisition unit 208 is transmitted to the controller 204. The GPS receiver as a satellite signal receiver receives signals from a plurality of GPS satellites. Each GPS satellite is an artificial satellite that orbits around the earth. A satellite positioning system, that is, a navigation satellite system (NSS) is not limited to the GPS. Positional information may be detected based on signals from various satellite positioning systems. The NSS is not limited to a global navigation satellite system, and may include a quasi-zenith satellite system, for example, may “Galileo” in Europe or “Michibiki” that is operated integrally with the GPS in Japan.

The controller 204 is a computer that performs control of the host vehicle based on information acquired from the sensor 206, the positional information acquisition unit 208, and the like. The controller 204 substantially has a function as a store device in a case where the autonomous traveling vehicle 200A functions as a mobile store. The controller 204 is an example of a controller that receives the operation command from the server apparatus 100 and controls traveling of the autonomous traveling vehicle 200A as a moving object.

The controller 204 has a CPU and a main storage unit, and executes information processing using a program. The CPU is also referred to as a processor. The main storage unit of the controller 204 is an example of a main storage device. The CPU in the controller 204 executes a computer program developed to be executable in the main storage unit, and provides various functions. The main storage unit in the controller 204 stores the computer program that is executed by the CPU, data, and the like. The main storage unit in the controller 204 is a dynamic random access memory (DRAM), static random access memory (SRAM), a read only memory (ROM), or the like.

The controller 204 is connected to the storage unit 214. The storage unit 214 is a so-called external storage unit, is used as a storage area that supports the main storage unit of the controller 204, and stores the computer program that is executed by the CPU of the controller 204, data, and the like. The storage unit 214 is a hard disk drive, a solid state disk (SSD), or the like.

The controller 204 has, as functional modules, a plan generation unit 2041, an environment detection unit 2042, a task controller 2043, an information acquisition unit 2044, a commodity selection unit 2045, and a command generation unit 2046. Each functional module is implemented by the controller 204, that is, the CPU in the controller 204 executing a program stored in the main storage unit or the storage unit 214.

The plan generation unit 2041 acquires a command from the outside, for example, the server apparatus 100 or another autonomous traveling vehicle 200 and generates an operation plan of the host vehicle. For example, the plan generation unit 2041 acquires the operation command from the server apparatus 100 and generates the operation plan of the host vehicle. The operation plan is data that defines a route, along which the autonomous traveling vehicle 200A travels, and processing to be executed by the autonomous traveling vehicle 200A in a part or the whole of the route. As an example of data included in the operation command, for example, (1) and (2) described below are exemplified.

(1) Data Representing Route, Along which Host Vehicle Travels, by a Set of Road Links

The route, along which the host vehicle travels, may be automatically generated based on a given departure place and a destination with reference to map data stored in the storage unit 214. The route may be generated using an external service.

### (2) Data Representing Processing to be Executed by Host Vehicle at a Point on Route

The processing to be executed by the host vehicle on the route includes, but is not limited to, for example, “functioning as a mobile store”, “receiving a predetermined package”, “delivering a predetermined package”, and “receiving a receipt or a deposit receipt”. The operation plan generated by the plan generation unit 2041 is transmitted to the task controller 2043 described below.

For example, the plan generation unit 2041 acquires a command for commodity provision as a kind of operation command and generates a delivery plan of a commodity from the host vehicle to another vehicle, for example, another autonomous traveling vehicle 200 or the carrier apparatus 300 configured to carry the commodity to another autonomous traveling vehicle 200. The delivery plan of the commodity is data that defines delivery processing of the commodity to another autonomous traveling vehicle 200 or the carrier apparatus 300.

In addition, the plan generation unit 2041 acquires a command of commodity reception as a kind of operation command and generates a reception plan of a commodity from another vehicle, for example, another autonomous traveling vehicle 200 or the carrier apparatus 300 to the host vehicle. The reception plan of the commodity is data that defines reception processing of the commodity provided from another autonomous traveling vehicle 200 or the carrier apparatus 300. An example of data including the reception plan of the commodity is, but not limited to, for example, information regarding the commodity to be received, for example, the type of commodity and the number of commodities can be included. The reception plan of the commodity generated by the plan generation unit 2041 is transmitted to the task controller 2043 described below.

The environment detection unit 2042 detects an environment surrounding the vehicle based on data acquired by the sensor 206. A target of detection is, but not limited to, for example, the number or positions of lanes, the number or positions of vehicles around the host vehicle, the number or positions of obstacles (for example, pedestrians, bicycles, structures, buildings, or the like) around the host vehicle, the structure of roads, road signs, or the like. Any target of detection may be applied as long as the target of detection is needed for autonomous traveling. The environment detection unit 2042 may track a detected object. For example, a difference between coordinates of an object detected before one step and current coordinates of the object may be used to obtain a relative speed of the object. Data (hereinafter, referred to as environment data) relating to the environment detected by the environment detection unit 2042 is transmitted to the task controller 2043 described below.

The task controller 2043 controls traveling or the like of the host vehicle based on the operation plan generated by the plan generation unit 2041, the environment data generated by the environment detection unit 2042, and the positional information of the host vehicle acquired by the positional information acquisition unit 208. For example, the task controller 2043 makes the host vehicle travel along a predetermined route such that an obstacle does not enter a predetermined safety area centering on the host vehicle. As a method of making the vehicle autonomously travel, a known method can be employed. The task controller 2043 executes the delivery processing of the commodity based on the delivery plan of the commodity generated by the plan generation unit 2041 or executes the reception processing of the commodity based on the reception plan of the commodity generated by the plan generation unit 2041. In this way, the task controller 2043 also executes a task other than traveling control.

In a case where the host vehicle is operated as a mobile store, the information acquisition unit 2044 acquires index information representing a tendency having interest in a commodity of a store visit user who visits the mobile store. Here, the index information is generated and acquired by executing predetermined processing according to a predetermined stored program based on information acquired by the commodity reader 216. A handling situation of a commodity of the store visit user can be read by the commodity reader 216. Then, the information acquisition unit 2044 acquires the index information based on information acquired by the commodity reader 216. In addition, the information acquisition unit 2044 acquires or the like an inventory information database 2141 stored in the storage unit 214 at regular intervals and provides, that is, transmits the inventory information database 2141 to the external server apparatus 100.

The commodity reader 216 is an example of a commodity sensor, and is, in the autonomous traveling vehicle 200A, a reader/writer, that is, a reader of a radio frequency identification (RFID). In this case, a commodity is attached with an RF tag as a noncontact IC tag. For example, in a case where a store visit user brings clothing as a commodity to be dealt by the autonomous traveling vehicle 200A into a partial area of the autonomous traveling vehicle 200A functioning as a clothing store, for example, a fitting room, an RF tag attached to the clothing is read by the commodity reader 216 provided in the fitting room. With this, the controller 204 can acquire information representing a tendency having interest of the store visit user before commodity purchase of the store visit user. In the RF tag, information of a commodity, for example, a manufacturer name, a brand name, a model number, and the like may be included. Such information may be acquired with commodity purchase of the store visit user.

The commodity selection unit 2045 selects a recommended commodity out of stock in the host vehicle based on the index information acquired by the information acquisition unit 2044. Here, the commodity selection unit 2045 of the controller 204 is configured to access a commodity information database 1062 provided from the server apparatus 100, that is, commodity information. Then, the commodity selection unit 2045 of the controller 204 searches the commodity information database 1062 based on the index information, thereby selecting a commodity. The selected commodity becomes a recommended commodity.

In a case where the autonomous traveling vehicle 200 includes a user reader that reads user information from a terminal or the like carried with the user, a device that enables an input of user information, or the like, the commodity selection unit 2045 may select a recommended commodity more suitable for the user also based on the user information. For example, a user ID may be acquired as the user information. In this case, a copy of a user information database 1061 may be provided from a storage unit 106 of the server apparatus 100 and stored in the storage unit 214. The user information database 1061 is constructed such that a characteristic (for example, sex, age, or physique) or the like of the store visit user is searchable based on the user ID. Here, although the user information database 1061 is provided from a management server that manages the user information to the server apparatus 100, the disclosure is not limited thereto.

The command generation unit 2046 generates a command to be provided, that is, transmitted to the outside and transmits the command to the outside. Examples of the command include the above-described operation command. The operation command is generated, for example, as a command of causing traveling of another autonomous traveling vehicle to provide the recommended commodity. A command of commodity provision as a kind of operation command is generated as a command of causing movement of the recommended commodity from the autonomous traveling vehicle 200 loading the recommended commodity, that is, the mobile store to a provision destination of the recommended commodity in a case where the recommended commodity is selected by the commodity selection unit 2045. In generating the commands, positional information or vehicle information of a vehicle information database 1063 provided from the server apparatus 100 and stored in the storage unit 214 is referred to, and information regarding the autonomous traveling vehicle 200 that sends the command is extracted. In a case where the user information of the store visit user is acquired, a part or the whole of the user information may be included in the command. In a case where the recommended commodity is carried along with the user information included in the command, the recommended commodity may be provided directly to the store visit user.

The drive unit 210 is a unit that makes the host vehicle travel or executes delivery and reception of the commodity based on the command generated by the task controller 2043. The drive unit 210 includes, for example, a motor for driving wheels, an inverter, a brake, a steering mechanism, a secondary battery, and the like. The drive unit 210 includes a motor or the like in a mechanism of package carrying-out or carrying-in for executing package delivery.

The communication unit 212 has a communication function for connecting the information processing apparatus 202, that is, the controller 204 to the network N. In the embodiment, the autonomous traveling vehicle 200A can perform communication with another apparatus, for example, the server apparatus 100 by way of the network N. The communication unit 212 further has a communication unit that allows the autonomous traveling vehicle 200A as the host vehicle to perform inter-vehicle communication with other autonomous traveling vehicles 200 (200B, . . . ).

The autonomous traveling vehicle 200A can have a unit for loading a package, a commodity showcase, or a galley. The autonomous traveling vehicle 200A includes a mechanism that delivers solely a predetermined package among a plurality of packages. For example, a housing apparatus having a plurality of housing areas (also referred to as blocks) may be provided in a vehicle cabin, and solely a permitted block may be unlocked. The autonomous traveling vehicle 200A includes a mechanism that delivers a loaded package to another apparatus. For example, the autonomous traveling vehicle 200A may include a mechanism that is connected to an external housing apparatus, such as a home delivery locker, and transfers a package. The autonomous traveling vehicle 200A includes a device that performs electronic payment in selling a commodity or the like. The autonomous traveling vehicle 200A may include a device that issues a receipt or a deposit receipt. The units, such as the mechanisms or the devices, are controlled by the task controller 2043.

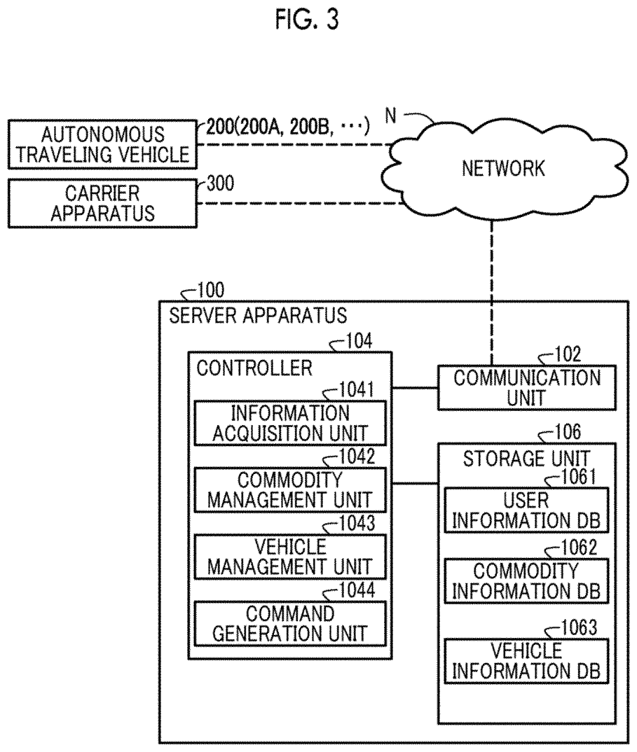

Next, the server apparatus 100 will be described referring to FIG. 3. The server apparatus 100 can perform communication with the autonomous traveling vehicles 200 and the carrier apparatus 300. The server apparatus 100 manages the operations or states of all autonomous traveling vehicles 200 in the mall M.

The server apparatus 100 has a communication unit 102, a controller 104, and the storage unit 106. The communication unit 102 is the same as the communication unit 212, and has a communication function for connecting the server apparatus 100 to the network N. The controller 104 has a CPU and a main storage unit similarly to the controller 204, and executes information processing using a program. Of course, the CPU is also a processor, and the main storage unit of the controller 104 is also an example of a main storage device. The CPU in the controller 104 executes a computer program developed to be executable in the main storage unit, and provides various functions. The main storage unit in the controller 104 stores the computer program that is executed by the CPU, data, and the like. The main storage unit in the controller 104 is, a DRAM, a SRAM, a ROM, or the like.

The controller 104 is connected to the storage unit 106. The storage unit 106 is an external storage unit, is used as a storage area that supports the main storage unit of the controller 104, and stores the computer program that is executed by the CPU of the controller 104, data, and the like. The storage unit 106 is a hard disk drive, an SSD, or the like.

The controller 104 is a unit that controls the server apparatus 100. The controller 104 has, as functional modules, an information acquisition unit 1041, a commodity management unit 1042, a vehicle management unit 1043, and a command generation unit 1044. The functional modules are implemented by the CPU of the controller 104 executing a program stored in the main storage unit or the storage unit 106.

The information acquisition unit 1041 of the server apparatus 100 acquires information regarding an inventory of commodities from the autonomous traveling vehicle 200 or information regarding a command or the like. The information acquisition unit 1041 accesses the commodity information database 1062 or the vehicle information database 1063 stored in the storage unit 106 and provides a copy of the commodity information database 1062 or the vehicle information database 1063 to the autonomous traveling vehicle 200. The information acquisition unit 1041 may access the user information database 1061 stored in the storage unit 106 and may provide a copy of the user information database 1061 to the autonomous traveling vehicle 200.

The commodity management unit 1042 arranges and stores information regarding loaded commodities provided from the information acquisition units 2044 of all autonomous traveling vehicles 200 in the mall M in the commodity information database 1062 of the storage unit 106. Here, the commodity information database 1062 includes information regarding commodities relating all autonomous traveling vehicles 200 in the mall M, that is, the mobile stores. In the storage unit 214 of each autonomous traveling vehicle 200, the inventory information database 2141 including information regarding an inventory of commodities loaded on the host vehicle. Information of the inventory information database 2141 is sent from the information acquisition unit 2044 of the autonomous traveling vehicle 200 to the commodity management unit 1042 of the controller 104 of the server apparatus 100 and is stored in the commodity information database 1062. The commodity information database 1062 is constructed such that information regarding the commodities loaded on all autonomous traveling vehicles 200 in the mall M is searchable based on the index information. A program or data needed for construction is stored in the storage unit 106, but may be stored in the main storage unit of the controller 104. In the commodity information database 1062 of the first embodiment, information regarding a commodity is associated with information regarding a mobile store dealing in the commodity, that is, information regarding the autonomous traveling vehicle 200, for example, a vehicle IT).

The vehicle management unit 1043 manages the autonomous traveling vehicles 200 under management. Specifically, the server apparatus 100 receives information, such as data relating to the autonomous traveling vehicles 200 from all autonomous traveling vehicles 200 in the mall M at a predetermined cycle, and the vehicle management unit 1043 of the controller 104 stores the received information a vehicle information database 1064 of the storage unit 106. As information relating to the autonomous traveling vehicles 200, the positional information and the vehicle information are used. The vehicle information is, but not limited to, for example, an identifier of the autonomous traveling vehicle 200, the purpose or classification of the autonomous traveling vehicle 200, information regarding a standby point (garage or service office door type, a vehicle body size, a trunk size, a load capacity, a full charge traveling range, a traveling range at the present time, a current status, and the like. The current status includes the type of store, the quantity or type of loaded commodities, and the like.

The command generation unit 1044 corresponds to and has the same function as the command generation unit 2046 of the autonomous traveling vehicle 200. For example, in a case where the server apparatus 100 acquires information for constructing the mall M, the command generation unit 1044 generates the command to the autonomous traveling vehicles 200, in particular, the operation command so as to construct the mall M in a predetermined period, and transmits the operation command to the autonomous traveling vehicles 200.

Next, the carrier apparatus 300 will be described. As shown in FIG. 1, the carrier apparatus 300 moves around the autonomous traveling vehicles 200 in the mall M, that is, the mobile stores and performs reception and delivery of commodities among the mobile stores. Similarly to the autonomous traveling vehicles 200, the carrier apparatus 300 is configured to perform autonomous traveling. As shown in FIG. 1, the carrier apparatus 300 is configured to move a place corresponding to the inside of each autonomous traveling vehicle 200 included in the mall M, that is, a backyard in a predetermined direction, but may move in a direction opposite to the predetermined direction.

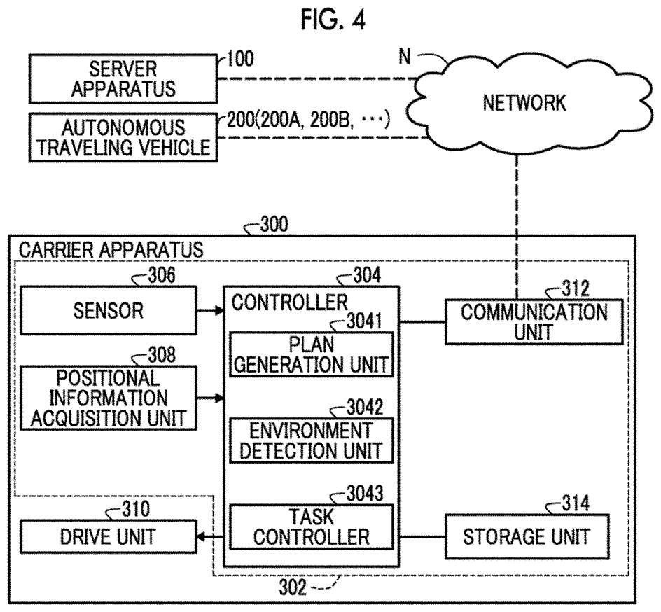

The carrier apparatus 300 will be further described referring to FIG. 4. The carrier apparatus 300 includes an information processing apparatus 302, and has a controller 304 that substantially has the functions of the information processing apparatus 302. The carrier apparatus 300 is a vehicle that operates according to the command acquired from the server apparatus 100, the autonomous traveling vehicle 200, or the like, and travels, for example, according to the acquired operation command. Specifically, the carrier apparatus 300 generates a traveling route based on the operation command acquired through the network N and travels on a road using an appropriate method while sensing the surroundings of the vehicle. The carrier apparatus 300 can carry a commodity from a certain mobile store to another mobile store based on the command of commodity provision acquired through the network N.

The carrier apparatus 300 includes, in addition to the controller 304, a sensor 306, a positional information acquisition unit 308, a drive unit 310, a communication unit 312, and a storage unit 314. The carrier apparatus 300 operates with electric power supplied from the battery. In the carrier apparatus 300, the controller 304, the sensor 306, the positional information acquisition unit 308, the drive unit 310, the communication unit 312, and the storage unit 314 correspond to the controller 204, the sensor 206, the positional information acquisition unit 208, the drive unit 210, the communication unit 212, and the storage unit 214 in the autonomous traveling vehicle 200, respectively. The controller 304 has, as functional modules, a plan generation unit 3041, an environment detection unit 3042, and a task controller 3043. The functional modules correspond to the plan generation unit 2041, the environment detection unit 2042, and the task controller 2043 of the autonomous traveling vehicle 200, respectively, and are implemented by the controller 304, that is, the CPU in the controller 304 executing a program stored in the main storage unit of the controller 304 or the storage unit 314. In this way, the components and functional modules of the carrier apparatus 300 correspond to those of the autonomous traveling vehicle 200, and thus, overlapping thereof will not be repeated. That is, similarly to the autonomous traveling vehicle 200, as described above, the carrier apparatus 300 can perform autonomous traveling toward a destination.

In FIGS. 1 to 4, the server apparatus 100, the autonomous traveling vehicles 200, and the carrier apparatus 300 are connected by the same network N. For example, a network that connects the server apparatus 100 and the autonomous traveling vehicles 200 may be different from a network that connects the server apparatus 100 and the carrier apparatus 300.

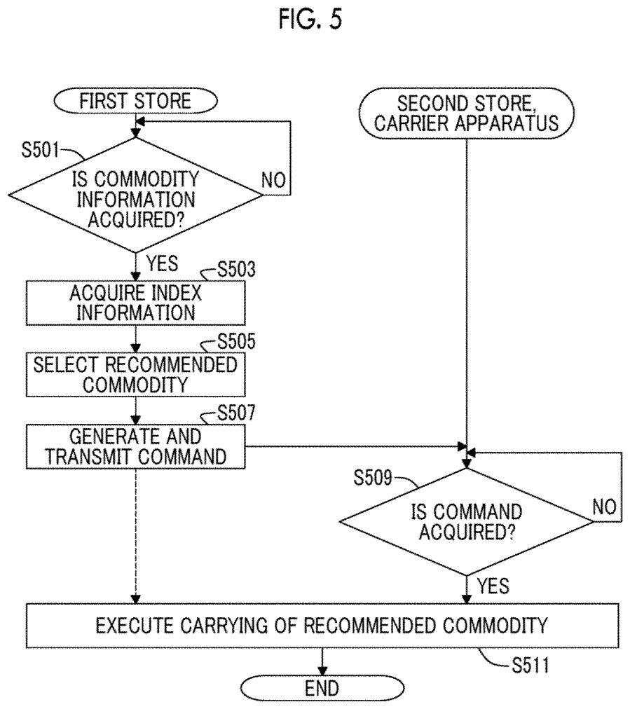

Information processing in each information processing apparatus of the system S1 having the above-described configuration will be described referring to a flowchart of FIG. 5. The flowchart of FIG. 5 shows a flow of information processing between the autonomous traveling vehicle 200A as a mobile store corresponding to a first store and the carrier apparatus 300 configured to carry a commodity between the first store and a second store, or the like. In FIG. 5, a time proceeds from an upper side toward a lower side in the drawing, and information processing therebetween is shown.

In the autonomous traveling vehicle 200A as the mobile store corresponding to the first store, for example, in a case where the store visit user takes a commodity in his/her hand or brings the commodity, and the commodity reaches in a predetermined area, the commodity reader 216 reads the RF tag of the commodity. With this, the information acquisition unit 2044 of the controller 204 can acquire information of the commodity (the determination in Step S501 is affirmative).

The information acquisition unit 2044 of the controller 204 executes predetermined processing according to a predetermined program based on the acquired information of the commodity to generate and acquire the index information (Step S503).

In the mall M of the first embodiment, a clothing store, a shoe store, and the like are provided as a mobile store, and the autonomous traveling vehicle 200A functions as a mobile store of a clothing store. In the autonomous traveling vehicle 200A as the first store, in a case where the store visit user brings a commodity “clothing 1” into the fitting room, the commodity reader 216 reads the RF tag attached to the commodity “clothing 1”, whereby information of the commodity “clothing 1” is acquired. Then, the information acquisition unit 2044 of the controller 204 executes predetermined processing based on information of the commodity “clothing 1”, thereby generating and acquiring index information representing the tendency having interest of the store visit user. The generation of the index information is executed according to the program stored in the storage unit. For example, in the generated index information, information regarding the genre “party” of the commodity “clothing 1” is included. Accordingly, another commodity that fits the genre “party”, that is, the recommended commodity can be selected in a step described below. In the index information, not only the genre of the commodity “clothing 1”, but also information regarding size, sex, such as for male or for female, color, and the like may be included. In the index information, information of clothing of the commodity “clothing 1” is also included. This is to restrain a commodity dealt by the mobile store from being repeatedly recommended in a case where the store visit user selects clothing.

The commodity selection unit 2045 of the controller 204 of the autonomous traveling vehicle 200A selects the recommended commodity based on the acquired index information (Step S505). The commodity information database 1062 stored in the storage unit 106 is searched based on the index information, whereby the controller 204 of the autonomous traveling vehicle 200A, in particular, the commodity selection unit 2045 of the controller 204 selects a commodity not in the autonomous traveling vehicle 200A, that is, the recommended commodity out of stock in the autonomous traveling vehicle 200A.

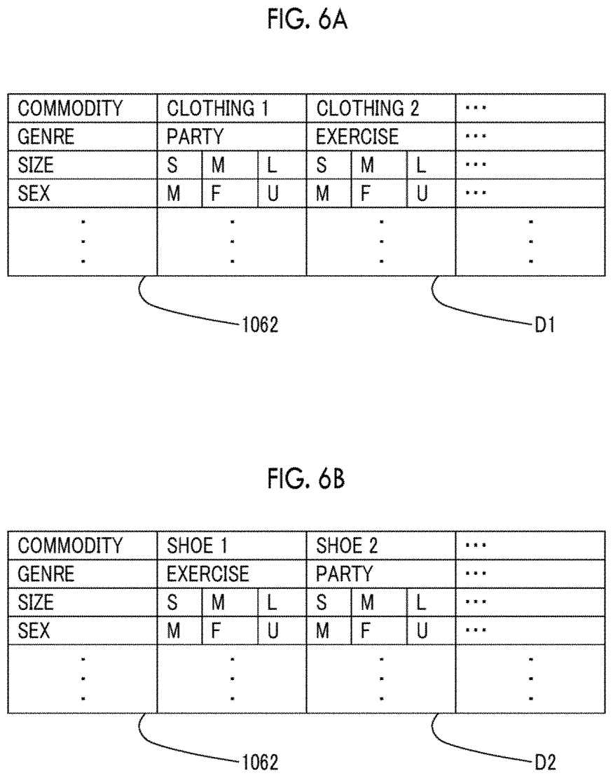

An example of the commodity information database 1062 is shown in FIGS. 6A and 6B. FIG. 6A shows first data relating to a commodity “clothing” in the commodity information database 1062. The commodity selection unit 2045 of the controller 204 of the autonomous traveling vehicle 200A excludes the first data of FIG. 6A from data to be searched based on the index information. This is because Information of “clothing” is included in the acquired index information as described above. Then, the commodity selection unit 2045 searches for second data shown in FIG. 6B in the commodity information database 1062. The second data of FIG. 6B is data relating to a commodity “shoe”, and is constructed to be searchable based on the index information, for example, the genre in the index information. The second data D2 of FIG. 6B of the commodity information database 1062 is constructed based on the inventory information database 2141 of the storage unit 214 of the autonomous traveling vehicle 200B. The first data D1 of FIG. 6A of the commodity information database 1062 is constructed based on the inventory information database 2141 of the storage unit 214 of the autonomous traveling vehicle 200A. The commodity selection unit 2045 searches for the second data of FIG. 6B of the commodity information database 1062 based on the acquired index information, thereby selecting a commodity “shoe 2”.

In this case, since the second data of FIG. 6B of the commodity information database 1062 is associated with the autonomous traveling vehicle 200B, the recommended commodity is selected, whereby the autonomous traveling vehicle 200B as the mobile store dealing in the recommended commodity is also specified. The specified autonomous traveling vehicle 200B corresponds to the second store.

In this way, in a case where the recommended commodity is selected and the second store dealing in the recommended commodity is specified to the autonomous traveling vehicle 200B, a command is generated and transmitted so as to move the commodity “shoe 2” as the recommended commodity from the autonomous traveling vehicle 200B to the autonomous traveling vehicle 200A (Step S507). In the command described here, in addition to information of the recommended commodity, store information of the first store is included, and specifically, the positional information or the like of the autonomous traveling vehicle 200A is included. In the first embodiment, in a state in which the mall M is constructed, the mobile store expanded in the mall M, that is, the autonomous traveling vehicle 200B does not move. The command generation unit 2046 of the controller 204 of the autonomous traveling vehicle 200A transmits the command to the carrier apparatus 300 so as to move the recommended commodity from the autonomous traveling vehicle 200B to the autonomous traveling vehicle 200A. In this case, the command generation unit 2046 also transmits the command to the autonomous traveling vehicle 200B as the second store. This is to deliver the commodity “shoe 2” to the carrier apparatus 300.

In the embodiment, the commodity selection unit 2045 searches for the second data D2 based on the inventory information database 2141 of the storage unit 214 of the autonomous traveling vehicle 200B. However, the commodity selection unit 2045 does not necessarily perform such processing. For example, the commodity selection unit 2045 may search for both of the first data D1 and the second data D2 based on the index information, and for example, may further calculate a score of a commodity based on the characteristic (sex, age, or physique) or the like of the store visit user obtained as described above. Then, in a case where a commodity with a high score to the characteristic of the store visit user is present in the autonomous traveling vehicle 200B, the commodity selection unit 2045 selects the commodity as the recommended commodity, and the command generation unit 2046 may generate a command so as to move the recommended commodity from the autonomous traveling vehicle 200B to the autonomous traveling vehicle 200A.

In a case where the command is acquired (the determination in Step S509 is affirmative), the carrier apparatus 300 and the autonomous traveling vehicle 200B execute carrying of the commodity “shoe 2” as the recommended commodity to the autonomous traveling vehicle 200A (Step S511). This includes generating a plan with the plan generation unit in each of the carrier apparatus 300 and the autonomous traveling vehicles 200A, 200B, and executing the plan with each of the task controllers 2043, 3043.

With the movement of the autonomous traveling vehicle 200B through autonomous traveling or the like, in a case where the recommended commodity can be moved to the autonomous traveling vehicle 200A as the first store, the autonomous traveling vehicle 200A may transmit the generated command solely to the autonomous traveling vehicle 200B (Step S507). With this, the autonomous traveling vehicle 200B can autonomously travel to the autonomous traveling vehicle 200A in a case where the command is received.

As described above, in a case where the host vehicle is the mobile store as the first store, and in a case where the index information of the store visit user is acquired in the first store, the controller 204 of the information processing apparatus 202 of the autonomous traveling vehicle 200A selects the recommended commodity based on the index information, and then, generates the command to the carrier apparatus 300 or the autonomous traveling vehicle 200B as the second store so as to move the recommended commodity from the mobile store as the second store to the mobile store as the first store. With this, it is possible to appropriately perform movement of a commodity based on the command. Accordingly, it is possible to recommend a commodity of the second store as another store to the store visit user who visits the first store. Therefore, it is possible to suitably provide a commodity to the store visit user who visits the first store, without replenishing an inventory of the commodity in advance.

Next, a second embodiment of the disclosure will be described. A system according to the second embodiment is the substantially same as the above-described system S1, but is different from the system of the above-described first embodiment in that the selection of the recommended commodity based on the acquired index information, or the like is executed by the server apparatus 100. Hereinafter, the difference will be primarily described. The components corresponding to the components already described are represented by the same reference numerals, and overlapping description will not be repeated.

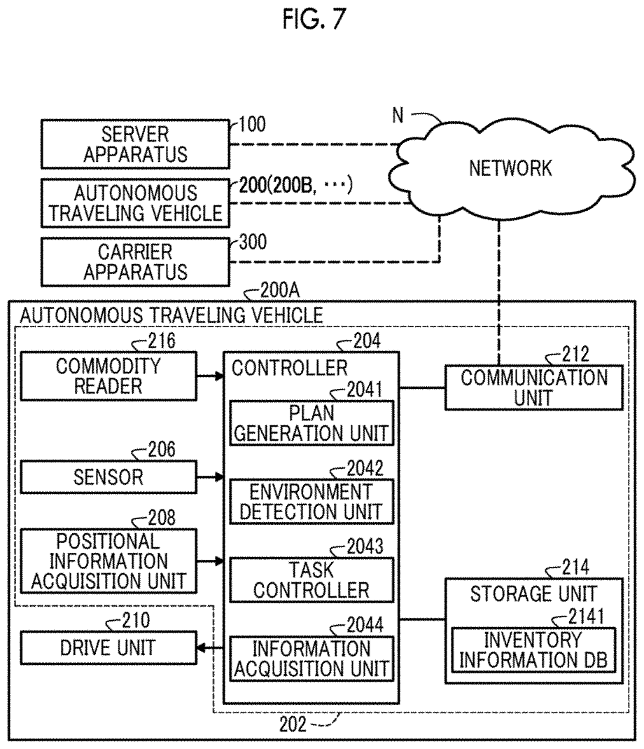

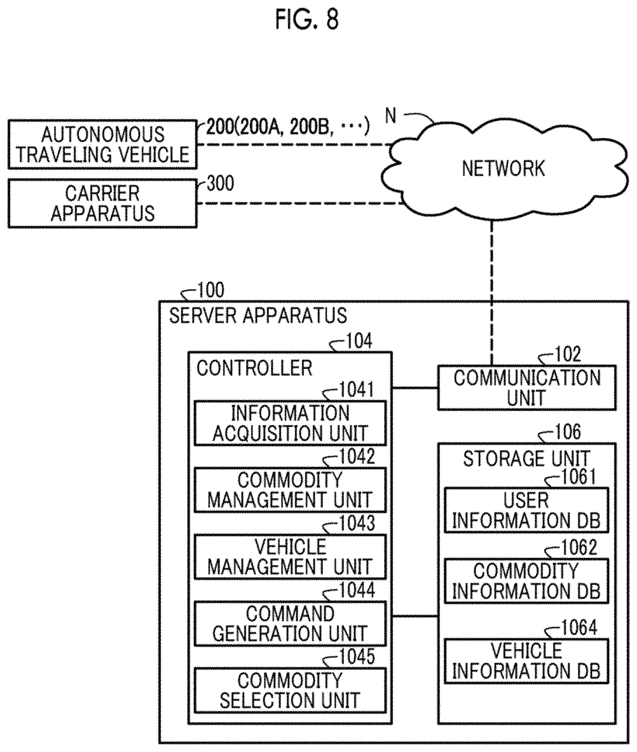

As shown in FIG. 7, the controller 204 of the autonomous traveling vehicle 200A has, as functional modules, a plan generation unit 2041, the environment detection unit 2042, the task controller 2043, and the information acquisition unit 2044, but does not include the commodity selection unit 2045 or the command generation unit 2046 described above. Instead, as shown in FIG. 8, the controller 104 of the server apparatus 100 as an information processing apparatus has, as a functional module, the commodity selection unit 1045, in addition to the information acquisition unit 1041, the commodity management unit 1042, the vehicle management unit 1043, and the command generation unit 1044. The commodity selection unit 1045 substantially corresponds to the above-described commodity selection unit 2045. Accordingly, detailed description of the commodity selection unit 1045 will not be repeated. As a result, as shown in FIG. 7, in the storage unit 106 of the autonomous traveling vehicle 200A, a copy of the commodity information database 1062 or the vehicle information database 1064 is not stored.

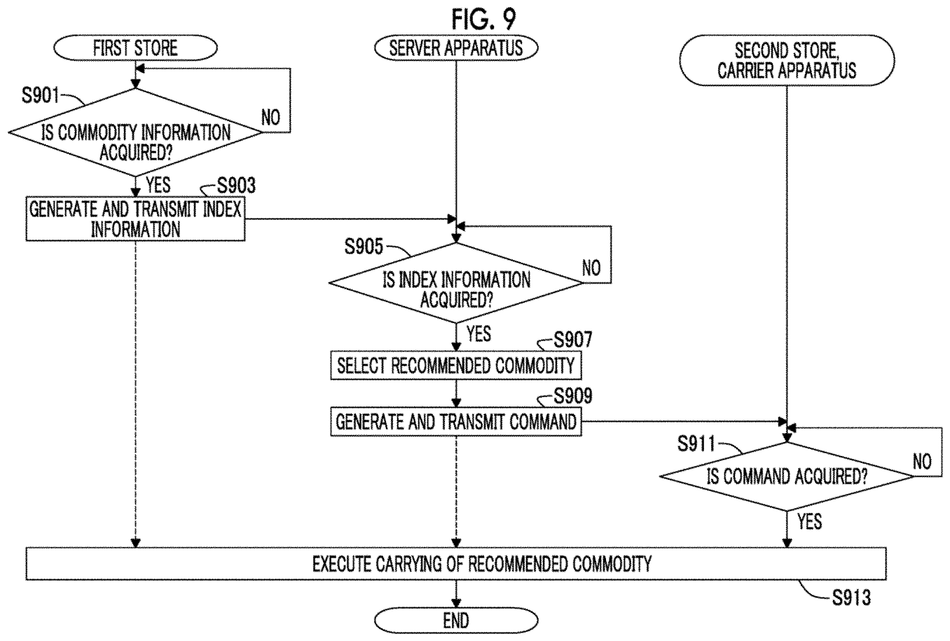

Information processing in various information processing apparatuses of the system having the above-described configuration will be described referring to a flowchart of FIG. 9. The flowchart of the FIG. 9 shows a flow of information processing among the autonomous traveling vehicle 200A as the mobile store corresponding to the first store, the server apparatus 100, and the carrier apparatus 300 configured to carry a commodity between the first store and the second store, or the like. In FIG. 9, as in FIG. 5, a time proceeds from an upper side toward a lower side in the drawing, and information processing therebetween is shown.

In the autonomous traveling vehicle 200A as the mobile store corresponding to the first store, in a case where information of a commodity drawing the interest of the store visit user is acquired (the determination in Step S901 is affirmative), the information acquisition unit 2044 of the controller 204 generates index information based on the acquired information of the commodity according to a predetermined program and transmits the index information to the server apparatus 100 (Step S903). Note that, in generating the index information, information of the autonomous traveling vehicle 200A is attached to the index information. Step S901 corresponds to Step S501 of FIG. 5.

In a case where the index information is acquired from the autonomous traveling vehicle 200A as the mobile store corresponding to the first store (the determination in Step S905 is affirmative), the server apparatus 100 selects the recommended commodity (Step S907). As in the first embodiment, here, the second store is specified to, for example, the autonomous traveling vehicle 200B. Steps S903 and S905 correspond to Step S503 of FIG. 5, and Step S907 corresponds to Step S505 of FIG. 5.

In this way, in a case where the recommended commodity is selected, and the second store dealing in the recommended commodity is specified to the autonomous traveling vehicle 200B, a command is generated and transmitted so as to move the recommended commodity from the autonomous traveling vehicle 200B to the autonomous traveling vehicle 200A (Step S909). In the command described here, the store information of the first store is included, and specifically, the positional information or the like of the autonomous traveling vehicle 200A is included. The command includes an operation command, a delivery command of a package, and a reception command of a package. In the second embodiment, in a state in which the mall M is constructed, the mobile store expanded in the mall M, that is, the autonomous traveling vehicle 200B does not move. The command generation unit 1044 of the controller 104 of the server apparatus 100 transmits the command to the carrier apparatus 300 so as to move the recommended commodity from the autonomous traveling vehicle 200B to the autonomous traveling vehicle 200A. In this case, the command generation unit 1044 also transmits the command to the autonomous traveling vehicle 200B as the second store. This is to deliver the commodity “shoe 2” to the carrier apparatus 300.

In a case where the command is acquired (the determination in Step S911 is affirmative), the carrier apparatus 300 and the autonomous traveling vehicle 200B execute carrying of the commodity “shoe 2” as the recommended commodity to the autonomous traveling vehicle 200A (Step S913). This includes generating a plan with the plan generation unit in each of the carrier apparatus 300 and the autonomous traveling vehicles 200A, 200B and executing the plan with each of the task controllers 2043, 3043.

With the movement of the autonomous traveling vehicle 200B, in a case where the recommended commodity can be moved to the autonomous traveling vehicle 200A as the first store, the server apparatus 100 transmits the generated command to the autonomous traveling vehicle 200B (Step S909), but may not transmit the command to the carrier apparatus 300. With this, the autonomous traveling vehicle 200B can perform autonomous traveling to the autonomous traveling vehicle 200A in a case where the command is received.

As described above, in a case where the index information of the store visit user is acquired in the mobile store as the first store, the server apparatus 100 as an information processing apparatus can select the recommended commodity based on the index information, and then, can generate and transmit the command including the store information or the like of the first store to the mobile store as the second store or the carrier apparatus 300 so as to move the recommended commodity from the mobile store as the second store to the mobile store as the first store. Accordingly, it is possible to recommend a commodity of the second store as another store to the store visit user who visits the first store. Therefore, it is possible to suitably provide a commodity to the store visit user who visits the first store, without replenishing an inventory of the commodity in advance.

Next, a third embodiment according to the disclosure will be described. Hereinafter, the third embodiment will be primarily described focusing on a difference from the second embodiment. The components corresponding to the components already described are represented by the same reference numerals, and overlapping description will not be repeated. In the third embodiment, as in the second embodiment, the server apparatus 100 executes the selection of the recommended commodity based on the acquired index information and the generation of the command accompanied by the selection of the recommended commodity. However, these kinds of processing may be executed by the autonomous traveling vehicle 200 as in the first embodiment.

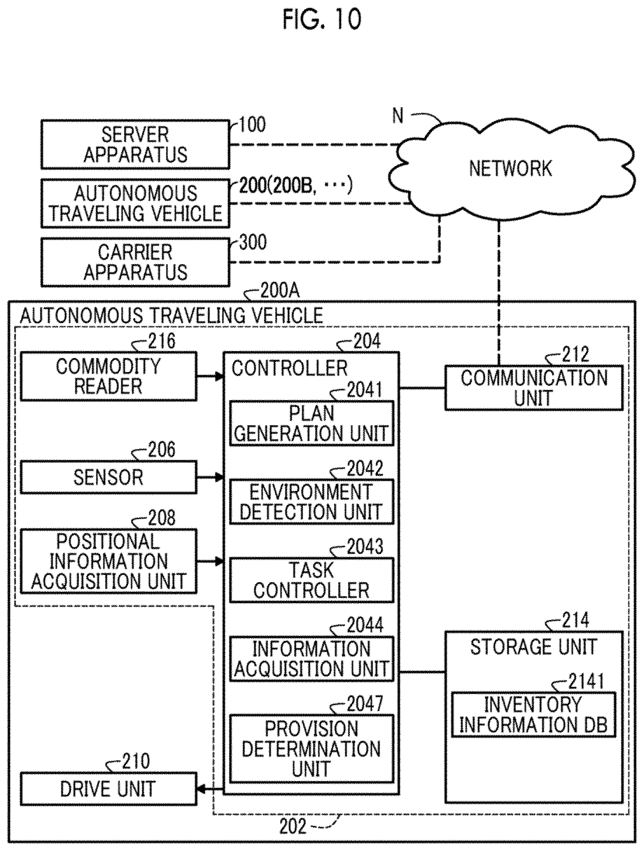

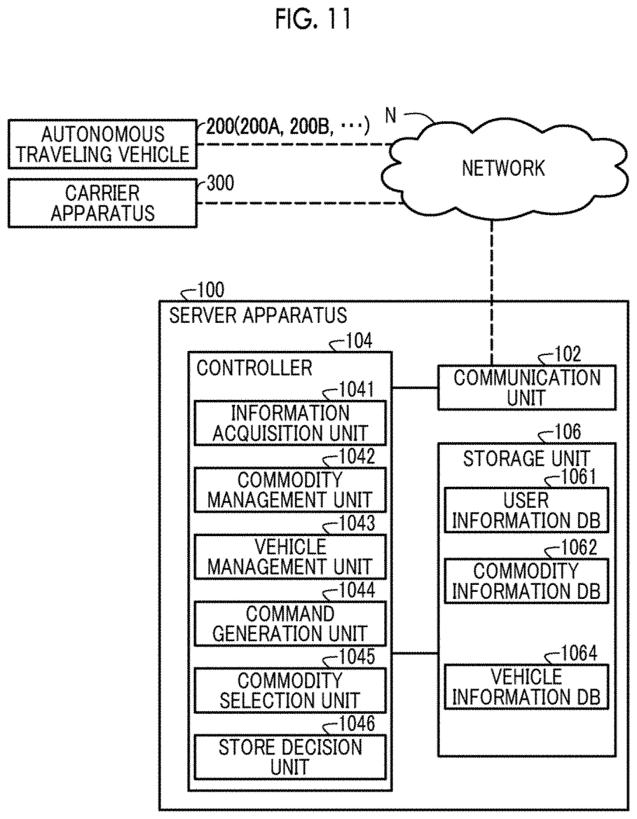

In the third embodiment, the autonomous traveling vehicle 200 has the same configuration as the autonomous traveling vehicle 200 in the above-described second embodiment. In addition, as shown in FIG. 10, the controller 204 of the autonomous traveling vehicle 200 includes, as a functional module, a provision determination unit 2047. The provision determination unit 2047 is configured as a functional unit that, in a case where the recommended commodity is requested to be provided, determines whether or not the recommended commodity can be provided and executes processing according to a determination result. In response to this, as shown in FIG. 11, the controller 104 of the server apparatus 100 further has, as a functional module, a store decision unit 1046 that decides a store for providing the recommended commodity. That is, a commodity and a store are not associated with each other in the commodity information database 1062. A commodity and a store may be associated with each other in the commodity information database 1062, and even in this case, the provision determination unit 2047 or the store decision unit 1046 described above may be provided in order to confirm the inventory situation of the commodity.

In a case where another autonomous traveling vehicle 200 is requested to provide a certain recommended commodity, the provision determination unit 2047 of the autonomous traveling vehicle 200 determines whether or not the recommended commodity can be provided and executes processing based on a determination result. Here, the inventory information database 2141 stored in the storage unit 214 is searched, whereby the provision determination unit 2047 determines whether or not the recommended commodity requested to be provided can be provided. In a case where the host vehicle is operated as the mobile store, the task controller 2043 of the controller 204 updates the inventory information database 2141, in which a state of an inventory of a commodity is recorded, based on information, such as the sales of the commodity, for example, barcode information. In a case where the host vehicle is operated as the mobile store, the task controller 2043 also updates and stores information of a stocked commodity in the inventory information database 2141. Then, in a case where determination is made whether or not the recommended commodity requested to be provided can be provided, the provision determination unit 2047 provides information regarding the determination result to the server apparatus 100. In a case where determination is made that the recommended commodity requested to be provided can be provided, the provision determination unit 2047 may provide the plan generation unit 2041 with a command of commodity provision to the autonomous traveling vehicle 200 as another mobile store, for example, the positional information of the autonomous traveling vehicle 200A, the types, the number, and the like of commodities to be provided.

The store decision unit 1046 of the server apparatus 100 collects the determination results from the autonomous traveling vehicles 200, in this case, all autonomous traveling vehicles 200 (200B, . . . ) included in the mall M other than the autonomous traveling vehicle 200A and specifies one or a plurality of autonomous traveling vehicles 200 as the second store. The number of recommended commodities may be plural unless the recommended commodities are the same.

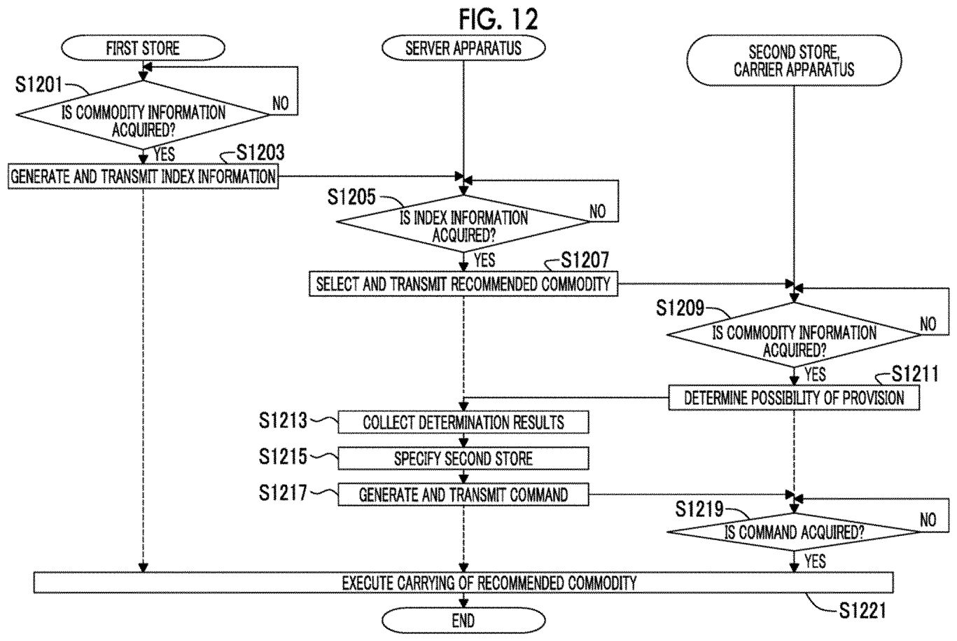

Information processing in various information processing apparatuses of the system having the above-described configuration will be described referring to a flowchart of FIG. 12. The flowchart of FIG. 12 shows a flow of information processing among the autonomous traveling vehicle 200A as the mobile store corresponding to the first store, the server apparatus 100, and the carrier apparatus 300 configured to carry a commodity between the first store and the second store, or the like. In FIG. 12, as in FIG. 5, a time proceeds from an upper side toward a lower side in the drawing, and information processing therebetween is shown. Steps S1201 to S1205 and S1217 to S1221 of FIG. 12 substantially correspond to Steps S901 to S905 and S909 to S913 of FIG. 9, respectively, and thus, detailed description thereof will not be repeated.

In the autonomous traveling vehicle 200A as the mobile store corresponding to the first store, in a case where information of the commodity is acquired (the determination in Step S1201 is affirmative), the information acquisition unit 2044 of the controller 204 generates index information based on the acquired information of the commodity and transmits the index information to the server apparatus 100 (Step S1203).

In a case where the index information is acquired from the autonomous traveling vehicle 200A as the mobile store corresponding to the first store (the determination in Step S1205 is affirmative), the commodity selection unit 1045 of the server apparatus 100 selects the recommended commodity (Step S1207). The selection of the recommended commodity is executed based on the index information. The commodity information database 1062 is searched based on the index information, whereby the controller 104 of the server apparatus 100, in particular, the commodity selection unit 1045 of the controller 104 selects a commodity not in the autonomous traveling vehicle 200A, that is, the recommended commodity out of stock (Step S1207). Then, in order to inquire whether or not the recommended commodity can be provided to the autonomous traveling vehicle 200A as the first store, information regarding the recommended commodity is transmitted to all autonomous traveling vehicles 200 (200B, . . . ) in the mall M other than the autonomous traveling vehicle 200A, that is, the mobile stores (Step S1207).

In all autonomous traveling vehicles 200 other than the autonomous traveling vehicle 200A, in a case where information regarding the recommended commodity is acquired (the determination in Step S1209 is affirmative), the provision determination unit 2047 of the controller 204 determines whether or not the recommended commodity can be provided and transmits, that is, returns a determination result to the server apparatus 100 (Step S1211). In the determination, information of the inventory information database 2141 of the storage unit 214 is employed.

Then, in the server apparatus 100, the store decision unit 1046 of the controller 104 collects the determination results from the autonomous traveling vehicles 200 (Step S1213), and specifies the second store (Step S1215). The specification of the second store is performed based on the determination result that the recommended commodity can be provided. As described in the first embodiment, for example, the store decision unit 1046 may calculate the score of the commodity based on the characteristic (for example, sex, age, or physique) of the store visit user with respect to the collected determination results from the autonomous traveling vehicle 200. Then, the autonomous traveling vehicle having a commodity with a high score to the characteristic of the store visit user in stock may be specified as the second store. In a case where the calculation of the score of the commodity is performed, the store decision unit 1046 may calculate the score with respect to the commodity in the autonomous traveling vehicle 200A as the mobile store corresponding to the first store in addition to the collected determination results from the autonomous traveling vehicles 200. Then, the autonomous traveling vehicle 200 having a commodity with a high score from all autonomous traveling vehicle 200 including the autonomous traveling vehicle 200A may be specified as the second store.

In this way, in a case where the recommended commodity is selected and the second store dealing in the recommended commodity is specified, a command is generated so as to move the recommended commodity from the specified second store (for example, the autonomous traveling vehicle 200B) to the autonomous traveling vehicle 200A and is transmitted to the carrier apparatus 300 or the like (Step S1217).

In a case where the command is acquired (the determination in Step S1219 is affirmative), the carrier apparatus 300 or the like executes carrying of the recommended commodity to the autonomous traveling vehicle 200A (Step S1221).

As described above, in a case where the index information of the store visit user is acquired in the mobile store as the first store, the server apparatus 100 as an information processing apparatus can select the recommended commodity based on the index information, then, can transmit information regarding the recommended commodity to stores in the mall M other than the first store M to specify the second store based on a result of communication with the stores, and can transmit the store information or the like of the first store so as to cause movement of the recommended commodity from the second store to the first store. In this way, it is possible to reliably recommend the recommended commodity to the store visit user of the first store according to the inventory of the second store.

Next, a fourth embodiment according to the disclosure will be described. Hereinafter, the fourth embodiment will be described focusing on a difference from the third embodiment. The components corresponding to the components already described are represented by the same reference numerals, and overlapping description will not be repeated.

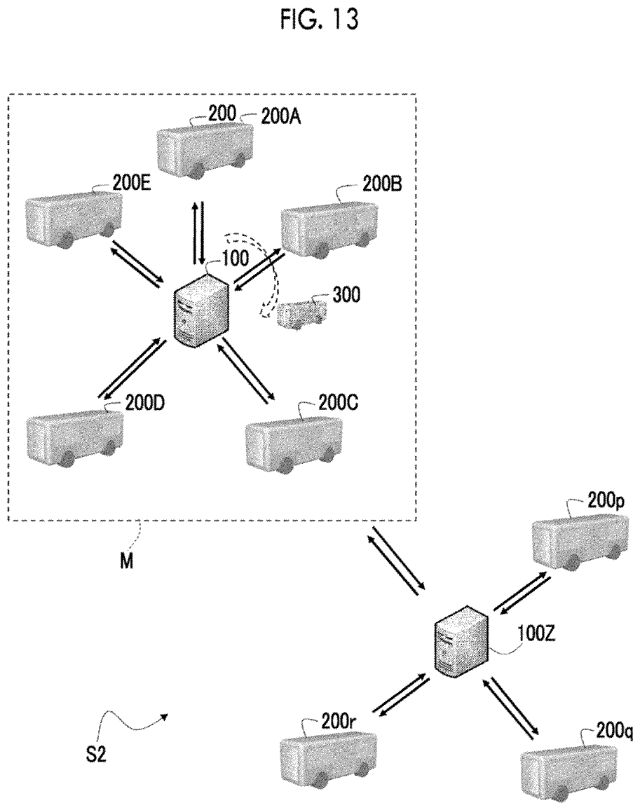

The system S2 in the fourth embodiment is shown in FIG. 13. In the fourth embodiment, in a case where the second store capable of providing the recommended commodity in the mall M cannot be specified, the recommended commodity can be provided from the outside of the mall M. As shown in FIG. 13, the server apparatus 100 relating to the mall M is configured to perform communication with a server apparatus 100Z outside the mall M through the network N. The server apparatus 100Z is configured to perform communication with autonomous traveling vehicles 200p, 200q, 200r through the network N.

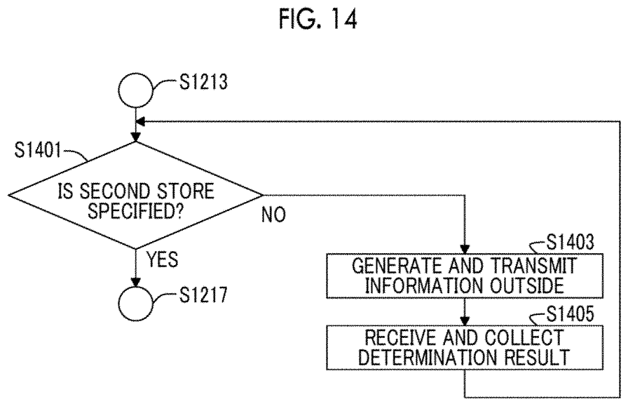

In the mall M, even though the store decision unit 1046 of the controller 104 of the server apparatus 100 collects the determination results from the autonomous traveling vehicles 200 (Step S1213 of FIG. 12), since there is no determination result that the recommended commodity can be provided, the second store cannot be specified. This will be described referring to FIG. 14. FIG. 14 shows solely steps that are inserted between Steps S1213 and S1217 of FIG. 12.

In a case where the second store cannot be specified (the determination in Step S1401 is affirmative), information of inquiring whether or not the recommended commodity can be provided, specifically, information including information regarding the recommended commodity is generated and transmit outside the mall M (Step S1403). With this, the server apparatus 100Z having the same configuration as the server apparatus 100 in the mall M can receive information regarding the recommended commodity, and the store decision unit 1046 of the controller 104 of the server apparatus 100Z can collect determination results of a possibility of providing the recommended commodity from the autonomous traveling vehicles 200p, 220q, 200r. As a result, the server apparatus 100 can receive the determination results (Step S1405).

Then, in a case where the store decision unit 1046 of the server apparatus 100 specifies the second store based on the determination result that the recommended commodity can be provided (the determination in Step S1401 is affirmative), an operation command of carrying the recommended commodity from the second store to the first store is generated and transmitted to, for example, the autonomous traveling vehicle 200p as the second store. The command includes the store information of the first store. With this, for example, in a case where the autonomous traveling vehicle 200p is specified as the second store, the autonomous traveling vehicle 200p can receive the store information of the first store and can perform autonomous traveling to the first store.

As described above, in the fourth embodiment, in a case where the recommended commodity to the store visit user of the first store is selected, it is possible to inquire the mobile stores in the mall of a possibility of providing the recommended commodity, and in the mobile stores in the mall, in a case where the recommended commodity cannot be provided, information can be transmitted outside the mall. Accordingly, it is possible to more reliably recommend the recommended commodity to the store visit user while primarily quickly recommending the recommended commodity to the store visit user of the first store.

The four embodiments of the disclosure have been described above. Among these, in the second to fourth embodiments, the server apparatus 100 executes the selection of the recommended commodity and the generation and transmission of the command for carrying the recommended commodity. However, the whole of these kinds of processing may be executed on the store side, that is, the autonomous traveling vehicle side as in the first embodiment. Solely a part of these kinds of processing may be executed on the autonomous traveling vehicle side.

Alternatively, information may be transmitted and received among the autonomous traveling vehicles 200 at regular intervals without passing through the server apparatus 100, and the commodity information database and the like may be constructed or updated. In this case, it is possible to suitably select the recommended commodity in the autonomous traveling vehicle.

The above-described embodiments are just examples, and the disclosure may be appropriately modified to be executed without departing from the spirit and scope of the disclosure. The processing or units described in the present disclosure can be freely combined and implemented as long as no technical contradiction arises.

Processing described to be executed by one apparatus may be shared and executed by a plurality of apparatuses. For example, the server apparatus 100 as an information processing apparatus does not need to be one computer, and may be constituted as a system including a plurality of computers. Alternatively, processing described to be executed by different apparatuses may be executed by one apparatus. In a computer system, a hardware configuration (server configuration) that implements each function may be flexibly changed.

The disclosure may also be implemented by supplying a computer program mounted with the functions described in the above-described embodiments to a computer and causing one or more processors in the computer to read and execute the program. Such a computer program may be provided to the computer by a non-transitory computer-readable storage medium connectable to a system bus of the computer or may be provided to the computer through a network. The non-transitory computer-readable storage medium includes, for example, any type of disk, such as a magnetic disk (a Floppy (Registered Trademark) disk, a hard disk drive (HDD), or the like), or an optical disk (a CD-ROM, a DVD, a Blu-ray disc, or the like), a read only memory (ROM), a random access memory (RAM), an EPROM, an EEPROM, a magnetic card, a flash memory, an optical card, or any type of medium suitable for storing electronic instructions.

What is claimed is:

1. An information processing apparatus comprising a controller configured to execute
acquiring index information representing a tendency having interest in a commodity of a store visit user in a first store,
selecting a recommended commodity out of stock in the first store based on the index information, and
generating a command to a carrier apparatus configured to carry a commodity between the first store and a second store dealing in the selected recommended commodity or the second store so as to move the selected recommended commodity from the second store to the first store.

2. The information processing apparatus according to claim 1, wherein:
the controller is configured to access commodity information that relates to a plurality of stores including the second store and is constructed to be searchable based on the index information; and
the selecting of the recommended commodity includes selecting the recommended commodity based on the commodity information.

3. The information processing apparatus according to claim 2, wherein:
in the commodity information, commodities and stores are associated with each other; and
the selecting of the recommended commodity includes specifying the second store associated with the selected recommended commodity.

4. The information processing apparatus according to claim 2, wherein the controller is configured to further execute transmitting information regarding the selected recommended commodity to the stores so as to inquire whether or not the selected recommended commodity is able to be provided to the first store and specifying the second store based on a result of communication with the stores.

5. The information processing apparatus according to claim 1, wherein:
the controller is configured to access commodity information that relates to a plurality of stores and is constructed to be searchable based on the index information;
the selecting of the recommended commodity includes selecting the recommended commodity based on the commodity information; and
the controller is configured to further execute transmitting information regarding the selected recommended commodity to a plurality of stores of a mall including the first store so as to inquire whether or not the selected recommended commodity is able to be provided to the first store, and in a case where the second store is unable to be specified based on a result of communication with the stores of the mall, transmitting information regarding the selected recommended commodity to an outside of the mall.

6. The information processing apparatus according to claim 1, wherein the carrier apparatus or the second store is configured to perform autonomous traveling to the first store in a case where the command is received.

7. An information processing method in which at least one computer executes
acquiring index information representing a tendency having interest in a commodity of a store visit user in a first store,
selecting a recommended commodity out of stock in the first store based on the index information, and
generating a command to a carrier apparatus configured to carry a commodity between the first store and a second store dealing in the selected recommended commodity or the second store so as to move the selected recommended commodity from the second store to the first store.

8. The information processing method according to claim 7, wherein:
the at least one computer is configured to access commodity information that relates to a plurality of stores including the second store and is constructed to be searchable based on the index information; and
the selecting of the recommended commodity includes selecting the recommended commodity based on the commodity information.

9. The information processing method according to claim 8, wherein:
in the commodity information, commodities and stores are associated with each other; and
the selecting of the recommended commodity includes specifying the second store associated with the selected recommended commodity.

10. The information processing method according to claim 8, wherein the at least one computer is configured to further execute transmitting information regarding the selected recommended commodity to the stores so as to inquire whether or not the selected recommended commodity is able to be provided to the first store and specifying the second store based on a result of communication with the stores.

11. The information processing method according to claim 7, wherein:
the at least one computer is configured to access commodity information that relates to a plurality of stores and is constructed to be searchable based on the index information;
the selecting of the recommended commodity includes selecting the recommended commodity based on the commodity information; and
the at least one computer is configured to further execute, transmitting information regarding the selected recommended commodity to a plurality of stores of a mall including the first store so as to inquire whether or not the selected recommended commodity is able to be provided to the first store, and in a case where the second store is unable to be specified based on a result of communication with the stores of the mall, transmitting information regarding the selected recommended commodity to an outside of the mall.

12. The information processing method according to claim 7, wherein the carrier apparatus or the second store is configured to perform autonomous traveling to the first store in a case where the command is received.

13. A program that causes at least one computer to execute
acquiring index information representing a tendency having interest in a commodity of a store visit user in a first store,
selecting a recommended commodity out of stock in the first store based on the index information, and
generating a command to a carrier apparatus configured to carry a commodity between the first store and a second store dealing in the selected recommended commodity or the second store so as to move the selected recommended commodity from the second store to the first store.
